(19) United States
(12) Patent Application Publication
(10) Pub. No.: US 2011/0253692 A1
(43) Pub. Date: Oct. 20, 2011

(54) Electrical heater for vehicle windshields and windows

(76) Inventor: Richard Egon Schauble, Calgary (CA)

(21) Appl. No.: 12/662,488

(22) Filed: Apr. 20, 2010

(51) Int. Cl. B60L 1/02; H01C 17/00; B23P 19/04

(52) U.S. Cl. 219/203; 29/428; 29/611

(57) ABSTRACT

An electrical heater for vehicle windshields and windows includes an electrically driven heater element and heater circuit wiring electrically connected to the element for electrically the element to produce heat from the element when energized, wherein the heater circuit wiring is adapted to only be electrically connected to a conventional DC electrical system of a vehicle, and wherein the heater element is adapted to only be mounted to the under-windshield vents of the vehicle to thereby direct airflow flowing over the heater element as forced by the vehicle's heater core fan through the vehicle ducting and out from the vehicle's under-windshield vents only onto the underside of the windshield.

### FIELD OF THE INVENTION

This invention relates to the field of heaters used in vehicles for producing warm air which may be directed onto windshields and windows of the vehicle, and in particular to a fanless electrical heater which co-operates with the conventional coolant-based forced air heaters provided in conventional vehicles which direct air which is heated by the vehicle's heater core through ducting so as to be directed onto the windshield and side window glass in the interior of the passenger compartment of the vehicle.

### BACKGROUND OF THE INVENTION

In the prior art applicant is aware of U.S. Pat. No. 2,827,540 which issued Mar. 18, 1958, to Underwood for an Auxiliary Electrical Heating System for Motor Vehicles. Underwood discloses an auxiliary heating system which operates in conjunction with a motor vehicle then conventional heating system to provide instantaneous heat during the period of time usually required for the conventional heating system to become effective, and in particular the time for the vehicle engine to heat water for the heater. The auxiliary heating system is disabled by a thermo-responsive element breaking the electrical circuit when the vehicles hot water heating system becomes operative. The heating element is taught as being disposed in front and in the path of air from, the conventional blower or fan of the conventional heating system. The arrangement of the element according to one aspect of the present invention is neither taught nor suggested. Further, it is neither taught nor suggested that in extreme winter conditions it is sometimes advantageous to simultaneously operate the electric heater along with the conventional vehicle heating system.

In the prior art, applicant is also aware of U.S. Pat. No. 3,469,073 which issued Sep. 23, 1969 to Zechin for an Electrical System. Zechin discloses an auxiliary electrical heating system which is operative during the transient warm-up, during which an engines coolant temperature is warmed once the engine is started. Zechin teaches that during the transient warm-up period an alternator is made to produce a higher voltage output than during its normal operation thus providing much greater heating capacity from the auxiliary resistance heater, the direct current (“DC”) load of the vehicle being provided by the vehicles battery during the transient warm-up period.

As discussed by Zechin, in conventional automobiles having conventional hot water heating systems, low ambient temperature conditions cause the vehicles engine coolant to also have the same temperature upon vehicle start-up thereby causing a substantial delay following the engines start-up before the engine coolant fluid temperature increases sufficiently to produce a comfortable output temperature from the vehicles conventional forced air ducted passenger compartment heating system. Zechin thus provides as an object the prevision of an auxiliary electrical heating system operable during a transient warm-up period of the primary heater system to produce a high BTU input into the passenger compartment of the vehicle and to provide a generator control system operable to produce a plurality of voltage outputs, one of which voltage outputs serves to energize the electrical resistance element of the auxiliary heater to improve the automobile heating and defrosting system. Zechin teaches including a circuit for supplying one of the voltage outputs as a regulated source to a DC load circuit and for supplying the other of the outputs to the electrical resistance element of the auxiliary heater without affecting the DC load circuit.

As also disclosed by Zechin, the electrical heating units may be arranged serially within the inlet duct work to the passenger compartment to simplify installation and ducting of the heater assembly. Zechin however continues that one problem with auxiliary electrical heating arrangements is that the electrical power output from present-day automobile power systems is typically limited to a regulated voltage usually in the range of 12 volts. As stated by Zechin, such a limited output voltage would require a very high current to supply an adequate electrically produced BTU input for warming the passenger compartment to a comfortable point during the transient warm-up period. Zechin thus provides the electrical resistance heater in association with a generator system which includes means for producing a BTU output at higher voltage from the electrical heater adequate to comfortably warm the vehicle passenger compartment during the transient warm-up, and for supplying a regulated limited voltage during other periods.

What applicant has determined, and which it is an object of the present invention to provide, is that if one reduces the expectation of Zechin from his stated objective of warming the passenger compartment of the vehicle to instead a targeted warm air defrosting of the vehicle windshield, by using efficient electrical resistance heaters, or efficient infrared radiation heaters, and with the strategic placement of the heater elements relative to the existing forced air heating system duct work in the vehicle, that effective defrosting may be obtained without the requirement of Zechin of producing a higher voltage than is normally available from a conventional vehicle alternator.

### SUMMARY OF THE INVENTION

The present invention mounts into a vehicle having a conventional DC electrical system, where the vehicle has a fan cooperating with a heater core of the vehicle engine, and forced-air ducting for providing heat from the heater core driven by the fan through the ducting to the passenger compartment of the vehicle via at least one under-windshield vent in the vehicle dashboard directed to the underside of the vehicle windshield.

In summary, the electrical heater according to one aspect of the present invention for defrosting vehicle windshields and windows may be characterized as including an electrically driven heater element and heater circuit wiring electrically connected to the element for electrically driving the element to produce heat from the element when so driven. The heater circuit wiring is adapted to only be electrically connected to the conventional DC electrical system of the vehicle. The heater element is also adapted in the windshield dedicated ducting branching off the primary general purpose ducting from the blower, for example the element may be adapted to only be mounted to or in the under-windshield vents of the vehicle to thereby direct airflow flowing over the heater element, as forced by the vehicle's fan through the vehicle's ducting and out from the vehicle's under-windshield vents only onto the underside of the windshield.

Advantageously at least one hazardous condition detector cooperates with the heater circuit wiring to shut-off the energizing of the heater element upon detection of a hazardous condition by the detector. For example, the hazardous condition detector may be adapted to detect hazards including overheating of the element, overheating of the vents or ducting, non-operative fan, non-operative vehicle engine.

Preferably the heater element is mounted into at least one of the under-windshield vents, or is mounted onto an upper surface of at least one of the under-windshield vents, so as to bring the heater element into closest proximity to the windshield while still cooperating with the forced-air airflow through and from the dashboard upper vent.

In one embodiment the heater element is adapted to be selectively removable when the mounted onto the upper surface, in which case the wiring may include a 12 volt plug (or other in-vehicle DC power plug) adapted to be plugged into, so as to electrically connect with, the corresponding DC outlet in the passenger compartment of the vehicle.

In one embodiment the heater element is only a single heater element adapted to be mounted to only a single under-windshield vent. The heater element may include a quartz carbon-fibre element, or may include an infrared radiator element or may include a ceramic or suitable and efficient electrically driven element.

In the method according to a further aspect of the present invention for installing the electrical heater described above, the following steps may be employed:
a) providing an electrically driven heater element;
b) providing heater circuit wiring and electrically connecting the wiring to the element to electrically drive the element to produce heat from the element,
c) mounting the heater element only to the under-windshield vents of the vehicle to thereby direct airflow flowing over the heater element as forced by the fan through the ducting and out from the under-windshield vents only onto the underside of the windshield.

In the method according to yet a further aspect of the present invention for making the electrical heater for the following steps may be employed:
a) providing an electrically driven heater element;
b) providing heater circuit wiring adapted for electrically connecting the wiring to the element to electrically drive the element to produce heat from the element when the element is energized, wherein the heater circuit wiring is adapted to only be electrically connected to the conventional DC electrical system of the vehicle,
c) providing the heater element adapted to only be mounted to the under-windshield vents of the vehicle to thereby direct airflow flowing over the heater element as forced by the fan through the ducting and out from the under-windshield vents only onto the underside of the windshield.

### BRIEF DESCRIPTION OF THE DRAWINGS

FIG. 1 is a diagrammatic representation of the electrical heater according to the present invention installed in the under-windshield vents of a vehicle forced-air ducted heating system.

FIG. 2 is the representation of FIG. 1 showing the electrical heater mounted over the under-windshield vents.

FIG. 3 is a simplified electrical schematic diagram of one embodiment of the electrical system controlling the electrical heater of the present invention.

### DETAILED DESCRIPTION OF EMBODIMENTS OF THE INVENTION

In a first embodiment of the present invention, which is not intended to be limiting, an electrical heating system according to the present invention may be installed on new vehicles at the time of their manufacturing by installing an electrically driven heater element 10 as close as possible to the ducting vent where it directs the air from the duct up onto the windshield. Heater element 10 may be for example a high efficiency electrical resistance heating element (such as for example a carbon fibre heating element); or an electrically driven radiation heating element such as an infrared radiation heater, for example quartz based.

In this embodiment the electrically driven heating element 10 is directly wired into the vehicle electrical system subject to some or all of the switching arrangements discussed below. The vehicles existing forced air fan is used to blow air through the vehicles heating system duct work to thereby force initially cold air to flow over the electrically driven heater element 10 to thereby provide immediate hot air directly onto the windshield, and in some vehicle designs having side ducting outlets, also directly onto the vehicle's side windows.

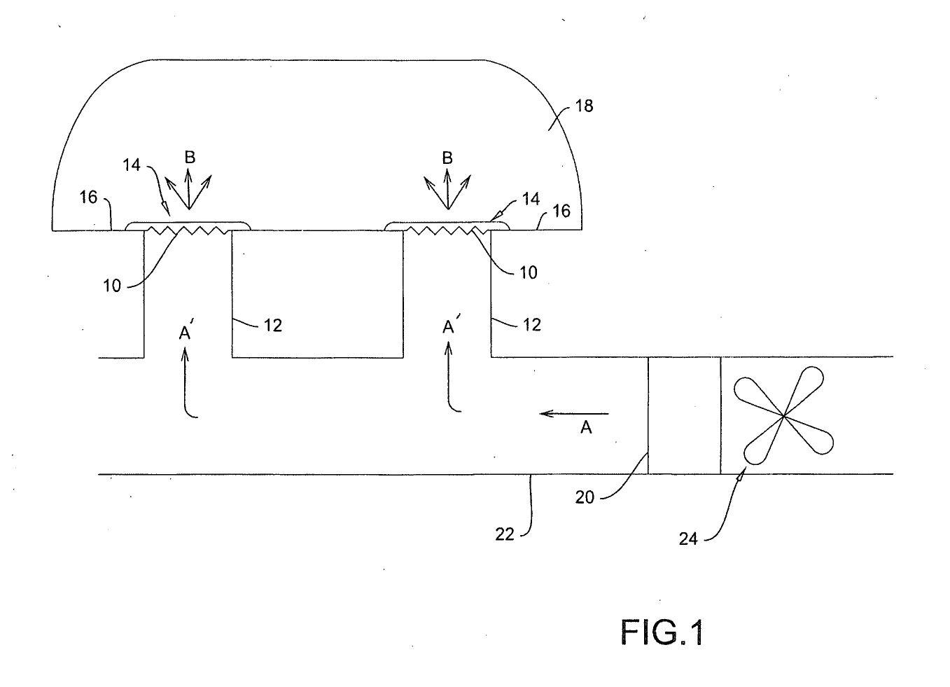

As seen in FIG. 1, electrically driven heater elements 10 are mounted in the vehicle under-dash ducting 12, that is, in the ducting dedicated to feeding the windshield vents and so as to direct air moving in direction A′, and not in the general or primary ducting 22 system. For example elements 10 may be mounted close to or directly under the dashboard vents 14 in the upper surface of dashboard 16 so long as within dedicated windshield ducts 12. Vents 14 are positioned by the manufacturer directly under the windshield 18. The vehicle engine coolant heater core 20 is mounted upstream relative to airflow direction A within the primary ducting 22 and typically immediately downstream of the vehicle's forced air fan 24. Air moving in direction A flows to the passenger compartment ducts (to the left in FIG. 1)

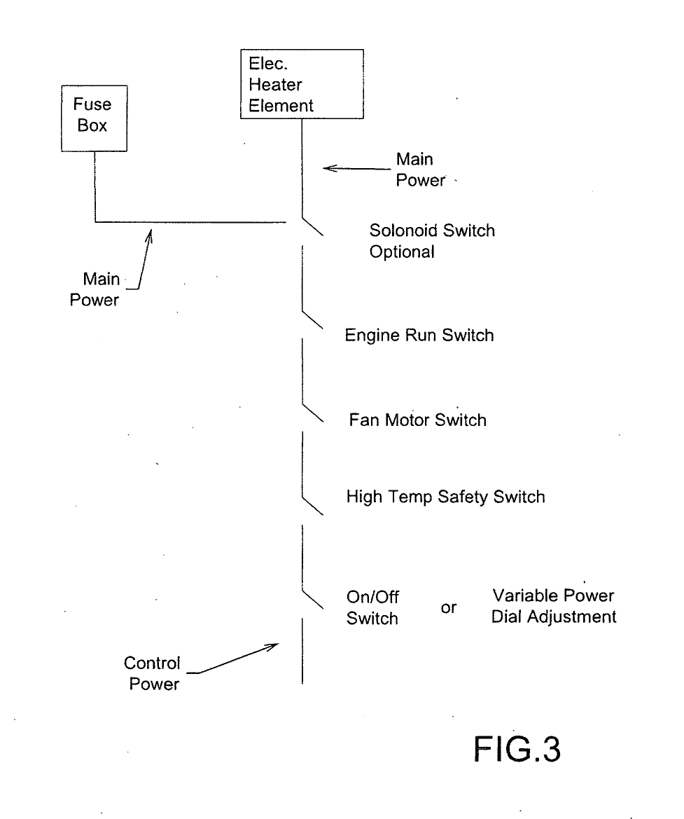

Preferably in this embodiment and as seen in FIG. 3 the electrically driven heater element 10 may not be energized without the vehicle's engine running so as to prevent the vehicles battery from being discharged. Consequently an automatic shut-off for driven heater element. 10 may be provided and also an on/off switch may be provided which may be manually controlled or for example automatically operate in conjunction with a temperature sensor sensing the temperature of both the ambient air and the engines coolant liquid. Further switching would also only allow the energizing of driven heater element 10 when the vehicle's forced air fan is running so as to prevent overheating of the heater element. In any event, advantageously a high temperature cut-off safety switch is mounted in proximity to heater element 10 so as to open, thereby cutting off electricity to heater element 10, if a temperature is detected which exceeds a preset safe temperature, for example that dictated by the material from which the automobile ducting is constructed.

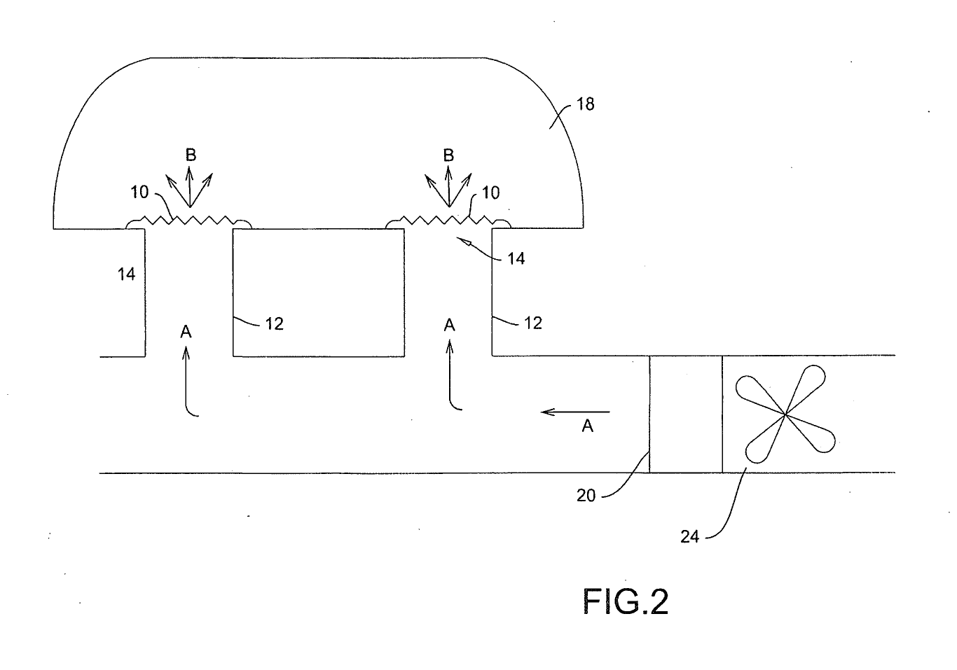

Applicant also intends after market embodiments of the present invention be included within the scope of the present invention. Namely, in one after market embodiment, electrically driven heater elements 10 are adapted to fit directly above the under-dash windshield vents 14 mounted into dashboard 16. The wiring system for this embodiment may simply include an on/off switch, a high temperature sensing safety switch, a fan operation detecting safety switch. Heater elements 10 may be directly wired for example to a 30 or 40 amp spare fuse outlet provided within the vehicle. Thus as seen in FIG. 2, in this embodiment heater elements 10 are mounted over vents 14. This provides the advantage of placing heater elements 10 in the closest proximity to the underside of windshield 18 so as to most efficiently transfer heat to the windshield from the warmed air exiting in direction B from vents 14. This placement also renders negligible any heat loss associated with contact between heated air leaving heater elements 10 and the initially cold interior surfaces of vents 14 and any grill work mounted thereover, where the surfaces of the ducting, vents and grill work will of course be initially at the ambient outside temperature. Further, applicant has noted that in many modern vehicles, the number of dashboard vents directed at the windshield has been reduced to merely one centred vent.

In a further after market embodiment, electrically driven heater elements 10 are mounted within a self contained heater housing (not shown) that attaches over vents 14 and mounts down onto dashboard 16. This embodiment would be the most easily installed by a user as it would be provided with a wiring cable which would merely plug into the conventional 12 volt outlet typically found in the passenger compartments of a vehicle. In this embodiment, heater elements 10 would be optimized for a conventional 15 amp capacity. An on/off switch would advantageously be provided so that heater elements 10 may be manually switched off even while the wiring remains plugged into the 12 volt outlet.

In one embodiment, the heater element housing may mount down onto dashboard 16 using for example a pair of spring-loaded clips where the clips are mounted directly to the dashboard. The housing mounts into the clips so as to be selectively removable therefrom. For example, the pair of clips may be mounted on either side of each of vents 14. Thus, forced air directed upwardly from vents 14 by forced air fan 24, flows over heater elements 10 then directly onto the underside of windshield 18, again, thereby keeping heater elements 10 in their most efficient position in closest proximity to the lower interior surface of the windshield.

As would be known to one skilled in art, the housing may advantageously be provided with insulation to avoid damage to, the upper surface to dashboard 16, for example in the instance where a user leaves the heater elements energized while the forced air fan 24 is turned off. Again advantageously, a temperature detecting safety switch would be mounted in the heater element housing so as to shut off the heater elements if the detected temperature exceeded a preset safety temperature. Further advantageously, a count down timer may be provided in a preferred embodiment that would shut off heater elements 10 automatically, for example after a 15 or 20 minute period of time, so as to provide both safety and so as to avoid draining the vehicle's battery if the heater elements were left turned on when the engine was shut off.

As will be noted, in all embodiments of the present invention, in order to avoid complex modifications to the vehicle electrical system as would be required if the teaching in the prior art was followed, in the present invention the conventionally available amperage is used in an optimized fashion by the placing of electrically driven high efficiency heater elements which are mounted as closely as practically possible in proximity to the automobile windshield so as to take advantage of the already existing forced air fan in the vehicles ducted forced air heating system and so as to negate heat loss to the initially cold side walls of the vehicles under dash ducting once the air flow has been heated by flowing over the electrically driven heating elements.

The present invention also avoids the problem in the prior art teaching where, in the event of a very cold weather engine start where the vehicle battery is barely capable of sufficient cranking amperage, transferring all of the DC load including that of the fan to the already overtaxed battery during the transient warm-up of the engine so that the alternator may exclusively provide increased voltage to an electric passenger compartment heater, may merely cause the battery to fail, and thus the engine to stop thereby shutting off the fan and alternator along with it. In such instances the passenger compartment heating circuit would have to be by-passed or switched off to allow the vehicle engine to warm-up and the passenger compartment to only thereafter be warmed conventionally. The present invention avoids this draw back of the prior art by merely operating on the conventionally available in-vehicle voltage and amperage. In very cold weather starts, the vehicle engine is started in the usual manner, for example with the fan and other electrically loading accessories shut-off. Once the engine starts then the fan etcetera may be immediately turned on along with the electrical windshield defroster according to the present invention, thereby allowing the vehicle to be quickly operated without prolonged idling, scraping of the windshield, etcetera. The reduction in vehicle idling saves the driver time, and improves fuel economy (idling gets zero miles per gallon), and reduces overall vehicle emissions per trip.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An electrical heater for vehicle windshields and windows in a vehicle having a conventional DC electrical system, a fan cooperating with a heater core of the vehicle engine, and forced-air ducting for providing heat from the heater core driven by the fan through the ducting to the passenger compartment of the vehicle via at least one under-windshield vent in the vehicle dashboard directed to the underside of the vehicle windshield, the heater comprising:
a) electrically driven heater element;
b) heater circuit wiring electrically connected to said element for electrically driving said element to produce heat from said element when so driven,
wherein said heater circuit wiring is adapted to only be electrically connected to the conventional DC electrical system of the vehicle,
and wherein said heater element is adapted to only be mounted to the under-windshield vents of the vehicle to thereby direct airflow flowing over said heater element as forced by the fan through the ducting and out from the under-windshield vents only onto the underside of the windshield.

2. The apparatus of claim 1 further comprising at least one hazardous condition detector cooperating with said heater circuit wiring to shut-off energizing of said heater element upon detection of a hazardous condition by said detector.

3. The apparatus of claim 2 wherein said hazardous condition detector is adapted to detect hazards chosen from the group comprising: overheating of said element, overheating of the vents or ducting, non-operative fan, non-operative vehicle engine.

4. The apparatus of claim 1 wherein said heater element is mounted into at least one of said under-windshield vents.

5. The apparatus of claim 1 wherein said heater element is mounted onto an upper surface of at least one of said under-windshield vents.

6. The apparatus of claim 5 wherein said heater element is adapted to be selectively removable when said mounted onto said upper surface.

7. The apparatus of claim 6 wherein said wiring includes a DC power plug adapted to be plugged into, so as to electrically connect with, a DC power outlet in the passenger compartment of the vehicle.

8. The apparatus of claim 1 wherein said heater element is only a single heater element adapted to be mounted to only a single under-windshield vent.

9. The apparatus of claim 8 wherein said heater element includes a carbon-fibre element.

10. The apparatus of claim 8 wherein said heater element includes an infrared radiator element.

11. A method for installing an electrical heater for defrosting vehicle windshields and windows in a vehicle having: a conventional DC electrical system, a fan cooperating with a heater core of the vehicle engine, and forced-air ducting for providing heat from the heater core driven by the fan through the ducting to the passenger compartment of the vehicle via at least one under-windshield vent in the vehicle dashboard directed to the underside of the vehicle windshield, the method comprising the steps of:
a) providing an electrically driven heater element;
b) providing heater circuit wiring and electrically connecting said wiring to said element to electrically drive said element to produce heat from said element, wherein said heater circuit wiring is adapted to only be electrically connected to the conventional DC electrical system of the vehicle,
c) mounting said heater element only to the under-windshield vents of the vehicle to thereby direct airflow flowing over said heater element as forced by the fan through the ducting and out from the under-windshield vents only onto the underside of the windshield.

12. The method of claim 11 further comprising providing at least one hazardous condition detector wired to said heater circuit to shut-off energizing of said heater element upon detection of a hazardous condition by said detector.

13. The method of claim 12 wherein said hazardous condition detector is adapted to detect hazards chosen from: overheating of said element, overheating of the vents or ducting, non-operative fan, non-operative vehicle engine.

14. The method of claim 11 wherein said heater element is mounted into at least one of said under-windshield vents so as to be immediately adjacent an upper outlet of said vents.

15. The method of claim 11 wherein said heater element is mounted onto an upper surface of at least one of said under-windshield vents.

16. The method of claim 15 wherein said heater element is mounted so as to be adapted to be selectively removable when said mounted onto said upper surface.

17. A method for making an electrical heater for defrosting vehicle windshields and windows in a vehicle having: a conventional DC electrical system, a fan cooperating with a heater core of the vehicle engine, and forced-air ducting for providing heat from the heater core driven by the fan through the ducting to the passenger compartment of the vehicle via at least one under-windshield vent in the vehicle dashboard directed to the underside of the vehicle windshield, the method comprising the steps of:
a) providing an electrically driven heater element;
b) providing heater circuit wiring adapted for electrically connecting said wiring to said element to electrically drive said element to produce heat from said element when said element is energized, wherein said heater circuit wiring is adapted to only be electrically connected to the conventional DC electrical system of the vehicle,
c) providing said heater element adapted to only be mounted to the under-windshield vents of the vehicle to thereby direct airflow flowing over said heater element as forced by the fan through the ducting and out from the under-windshield vents only onto the underside of the windshield.

18. The method of claim 11 further comprising providing at least one hazardous condition detector adapted to be wired to said heater circuit to shut-off energizing of said heater element upon detection of a hazardous condition by said detector.

19. The method of claim 11 wherein said heater element is adapted to be mounted into at least one of said under-windshield vents so as to be immediately adjacent an upper outlet of said vents.

20. The method of claim 11 wherein said heater element is adapted to be mounted onto an upper surface of at least one of said under-windshield vents.
